(19) United States
(12) Patent Application Publication
(10) Pub. No.: US 2021/0323012 A1
(43) Pub. Date: Oct. 21, 2021

(54) Liquid Dispenser

(71) Applicant: Mercuries Asia Ltd., Taipei City (TW)

(72) Inventors: Yeh-Yi Chung, Taipei City (TW); Hsin-Han Chen, Taipei City (TW)

(73) Assignee: Mercuries Asia Ltd.

(21) Appl. No.: 16/938,772

(22) Filed: Jul. 24, 2020

(30) Foreign Application Priority Data
Apr. 17, 2020 (TW) 109204590

(51) Int. Cl. B05B 9/08; B05B 9/04; B05B 9/043

(52) U.S. Cl. CPC B05B 9/0811; B05B 9/043; B05B 9/0426

(57) ABSTRACT

A liquid dispenser is mountable to a container having an interior portion. The liquid dispenser includes a pump and a pressurization tube that includes a first end connected to the pump, a second end in fluid communication with the container interior, and a pressure release aperture. The dispenser further includes a valve that is located in the housing and includes a first port in fluid communication with an outside area, a second port in fluid communication with the pressure relief aperture, and a third port in fluid communication with the interior cavity of the housing. The valve further includes a plug selectively movable between a first position, in which the plug blocks the third port, and a second position, in which the plug blocks the second port.

### CROSS-REFERENCE(S) TO RELATED APPLICATION(S)

This application claims priority to Taiwanese Patent Application No. 109204590, filed Apr. 17, 2020, which is hereby incorporated by reference in its entirety.

### BACKGROUND

The present disclosure relates generally to a liquid dispensing apparatus and more particularly a liquid dispensing apparatus that prevents backflow.

A liquid dispensing apparatus is a device for extracting a beverage from inside a container or bottle while mixing air in the beverage during the extraction process, which is common practice applied to red wine. As such, the air is added by the extraction process of red wine, so as achieve decanting. When applied to mineral water, the device can increase the dissolved oxygen in the mineral water extracted from the inside of the bottle, thereby enhancing the taste of the drink.

A liquid dispensing apparatus of the prior art is operated by an air pressurizing device (i.e., air pump), so that external air is pressurized and introduced into the container bottle. While maintaining a good airtight condition with the bottle mouth, the pressurized air exerts pressure on the surface of the liquid in the container, so that the liquid is pushed to the insertion tube of the housing, and then guided to the discharge tube to flow out of the container. The air is mixed into the liquid to be output through the air hole of the insertion tube, so as to achieve the function of decanting.

U.S. Pat. No. 7,882,986, “Liquid Dispenser,” discloses a liquid dispenser, including a housing, a liquid discharge tube, a pressurizing device, a pressure relief tube and a switch set, the housing is mounted to a bottle to form an airtight seal between the bottle and the housing, and an insertion tube extends into the bottle to the bottom of the bottle. The insertion tube is provided with an inner tube. An inlet end of the liquid discharge tube communicates with the inner tube. An inlet end of the pressure relief tube communicates with the insertion tube. The switch set comprises a switch button for opening and closing the pressurizing device, and a plug connected with the switch button to selectively block or leave the outlet end of the pressure relief tube. The user can operate the pressurizing device to pump the air into the container, so that the air pressure inside the bottle increases and presses the liquid into the cup through the inner tube and the liquid discharge tube. Through the air hole on the outer edge of the inner tube, the introduced air partially enters the inner tube through the air hole, and mixes with the red wine in the inner tube to achieve the effect of decanting. When the pressurizing device is closed, the pressure relief tube is no longer blocked by the plug and the high-pressure gas in the bottle overflows, which can immediately stop the flow of the liquid in the liquid discharge tube.

U.S. Pat. No. 9,862,590, “Electric Decanter,” discloses a liquid dispenser, which includes a body set, a liquid pump installed in the body set, and an inlet hole of the connection base of the body set is connected to an air inlet adjustment set on the outside, and an extracting tube is mounted to a first infusion tube of the connection base. The liquid inside the container is directly extracted through the liquid pump, so the execution of the liquid extraction action does not depend on whether the mouth of the container is maintained airtight. The size of the air inlet hole on the connection base can be adjusted by the air inlet adjustment set, so that the user must determine the opening extent of the air inlet hole according to the different types of liquid in the container. Because the extracting tube is a multi-stage retractable tube set, the user can shorten the extracting tube for easy carrying.

Chinese Patent No. CN206590882, “Air Inlet Adjustment Group and the Liquid Drawing Device with the Air Inlet Adjustment Group,” discloses a liquid suction unit that includes an air inlet hole. The air intake adjustment set has a valve base, an elastic member, and a valve stem. The valve base corresponds to the air inlet hole and has an abutment slope against a slope. Both ends of the elastic member are fixed on the valve base. One end of the valve stem penetrates the valve base and selectively blocks the internal space of the valve base. The valve stem has an abutment block, the abutment block can move along the abutment slope, and abuts against the abutment slope and the elastic member. Therefore, when the valve stem rotates, the abutment block moves against the abutment slope of the valve seat, so as to control the amount of air and liquid mixed. In addition, the elastic member continuously pushes against the abutment block against the abutment slope, even after the abutment block or the abutment slope is worn off, the air intake amount of the liquid suction unit can be accurately controlled.

However, during the process of liquid dispensing the prior art dispensers, when the pump stops operating, the air pressure in the container returns to the pump, and the liquid in the container can also return to the pump through the tube to cause a short circuit of the pump due to contact with the liquid, and more seriously, a short circuit of the control circuit board.

### SUMMARY

Embodiments of the disclosed liquid dispense enable a user to dispense liquid from a bottle or other container while preventing backflow. The liquid dispenser uses a solenoid valve to actuate a valve assembly so that the air pressure prevents the liquid in the container from returning to the pressurizing device during the return flow, thereby reducing the risk that liquid will damage the electronic components of the dispenser.

A first representative embodiment of a liquid dispenser is mountable to a container having an interior portion. The liquid dispenser includes a pump and a pressurization tube that includes a first end connected to the pump, a second end in fluid communication with the container interior, and a pressure release aperture. The dispenser further includes a valve that is located in the housing and includes a first port in fluid communication with an outside area, a second port in fluid communication with the pressure relief aperture, and a third port in fluid communication with the interior cavity of the housing. The valve further includes a plug selectively movable between a first position, in which the plug blocks the third port, and a second position, in which the plug blocks the second port.

In some embodiments, the liquid dispenser further includes an outlet tube extending laterally from the housing and having a first end in fluid communication with the interior of the container when the liquid dispenser is mounted to the container.

In some embodiments, the liquid dispenser further includes a dip tube having a first end in fluid connection with the first end of the outlet tube, the dip tube having a second end positioned near a bottom of the interior of the container when the liquid dispenser is mounted to the container.

In some embodiments, the dip tube has an adjustable length.

In some embodiments, the liquid dispenser further includes a switch selectively movable between a first switch position and a second switch position, wherein movement of the switch from the first switch position to the second switch position moves the valve from the first position to the second position.

In some embodiments, the movement of the switch from the first switch position to the second switch position activates the pump.

In some embodiments, the movement of the switch from the second switch position to the first switch position moves the valve from the second position to the first position.

In some embodiments, movement of the switch from the second switch position to the first switch position deactivates the pump.

In some embodiments, the liquid dispenser further includes an actuator operably coupled to the valve, the actuator selectively positioning the plug to reciprocate the valve between the first position and the second position.

In some embodiments, the actuator is a linear actuator.

In some embodiments, the actuator being a solenoid comprising a selectively retractable plunger, wherein the plug is mounted to the plunger.

In some embodiments, the liquid dispenser further includes a connecting element positioned on a bottom portion of the housing, the connecting element being sized and configured to engage an aperture formed in the container.

In some embodiments, the connecting element comprises an infusion tube having a first end in fluid connection with the outlet end of the pressurization tube, a second end of the infusion tube being in fluid connection with the interior portion of the container.

In some embodiments, the liquid dispenser further includes a dip tube selectively attachable to the connecting element; and a flexible cover engaging the connecting element to block the second end of the infusion tube when the dip tube is not attached to the connecting element, the dip tube deflecting the flexible cover to uncover the second end of the infusion tube when the dip tube is attached to the connecting element.

A second representative embodiment of a liquid dispenser according to aspects of the present disclosure is mountable to a neck of a bottle to sealingly engage a mouth of the bottle. The liquid dispenser includes a housing and a pump that is disposed within the housing and has an outlet. A pressurization tube has a first aperture in fluid communication with the pump outlet, a second aperture in fluid communication with an interior of the bottle, and a third aperture. The liquid dispenser further includes a valve disposed within the housing. The valve has a first port in fluid communication with an area outside of the housing, a second port in fluid communication with the third aperture of the pressurization tube, a third port in fluid communication with an interior cavity formed in the housing; and a plug selectively movable between a first position, in which the plug blocks the third port, and a second position, in which the plug blocks the second port. The first port is in fluid communication with the second port when the plug is in the first position, and the first port is in fluid communication with the third port when the plug is in the second position.

In some embodiments, the third aperture of the pressurization tube is positioned between the first and second apertures of the pressurization tube.

In some embodiments, the liquid dispenser further includes a connecting element extending from the housing, the connecting element being sized and configured to be at least partially received within the mouth of the bottle.

In some embodiments, the connecting element includes an infusion tube extending therethrough, a first end of the infusion tube being in fluid communication with the second aperture of the pressurization tube, a second end of the infusion tube being in fluid communication with the interior of the bottle.

In some embodiments, the liquid dispenser further includes a dip tube selectively attachable to the connecting element; and a flexible cover engaging the connecting element to block the second end of the infusion tube when the dip tube is not attached to the connecting element, the dip tube deflecting the flexible cover to uncover the second end of the infusion tube when the dip tube is attached to the connecting element.

In some embodiments, the liquid dispenser further includes an outlet tube extending laterally from the housing and having a first end in fluid communication with the dip tube.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of disclosed subject matter will become more readily appreciated as the same become better understood by reference to the following detailed description, when taken in conjunction with the accompanying drawings, wherein:

FIG. 1 is a top perspective view of a first representative embodiment of a liquid dispenser according to aspects of the present disclosure;

FIG. 2 is a bottom perspective view thereof;

FIG. 3 is an exploded view thereof;

FIG. 4 is an environmental perspective view thereof, wherein the liquid dispenser is mounted to a bottle;

FIG. 5 is an exploded view of a pump and valve assembly thereof;

FIG. 6 is a perspective view of the valve assembly shown in FIG. 5, wherein the valve assembly is in a first position;

FIG. 7 is a perspective view of the valve assembly shown in FIG. 5, wherein the valve assembly is in a second position;

FIG. 8 is a top perspective view of a second representative embodiment of a liquid dispenser according to aspects of the present disclosure; and

FIG. 9 is a top perspective view of a third representative embodiment of a liquid dispenser according to aspects of the present disclosure.

### DETAILED DESCRIPTION

The accompanying drawings are included to provide a further understanding of the disclosed subject matter, and are incorporated in and constitute a part of this specification. The drawings illustrate embodiments of the disclosed subject matter and, together with the description, serve to explain the principles of the disclosed subject matter.

Described embodiments of a liquid dispenser 100 enable a user to dispense liquid 210 from a container 200, such as a bottle, so that the process of dispensing the liquid also aerates the liquid. As will be explained in further detail, the disclosed liquid dispenser 100 also prevents backflow of the liquid 210 from the bottle 200 into interior portions of the liquid dispenser where the liquid could damage electrical components (such as a pump or solenoid) and/or electronics (such as a circuit board).

Disclosed embodiments of a liquid dispenser 100 are generally illustrated as being used to dispense wine from a typical glass wine bottle, however, it will be appreciated that the disclosure is not limited to a particular liquid or a particular container. In this regard, embodiments of the disclosed liquid dispensers may be used to dispense other beverages, such as carbonated water or juice, or any other suitable liquids, including liquids other than beverages. Further, embodiments are contemplated in which the liquid dispenser 100 is utilized with containers other than wine bottles. Such containers may be made from different materials of combinations of material, and may also take different forms according to the liquid contained therein and/or the environment in which the liquid is to be dispensed, or any other considerations. Contemplated embodiments of the disclosed liquid dispenser 100 may be used with these and other suitable containers, and such embodiments should be considered within the scope of the present disclosure.

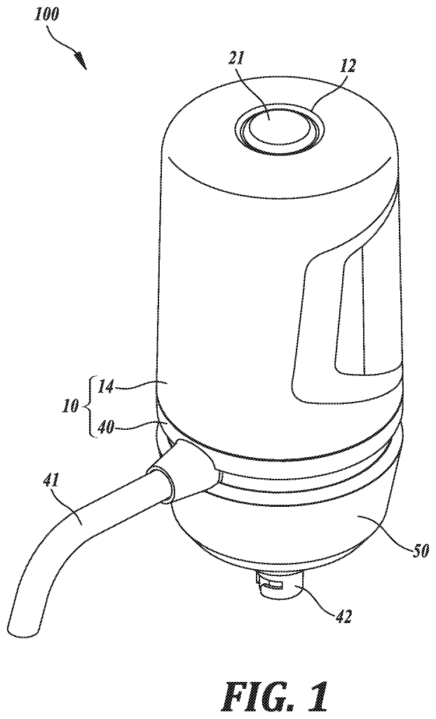

Referring now to FIGS. 1-7, a first representative embodiment of a liquid dispenser 100 will be described. As best shown in FIGS. 1-3, the liquid dispenser 100 includes a housing 10 formed by a cover 14 coupled to a base 40 to define an interior cavity 11. The cover 14 includes an aperture 12 extending through a top side of the cover 14.

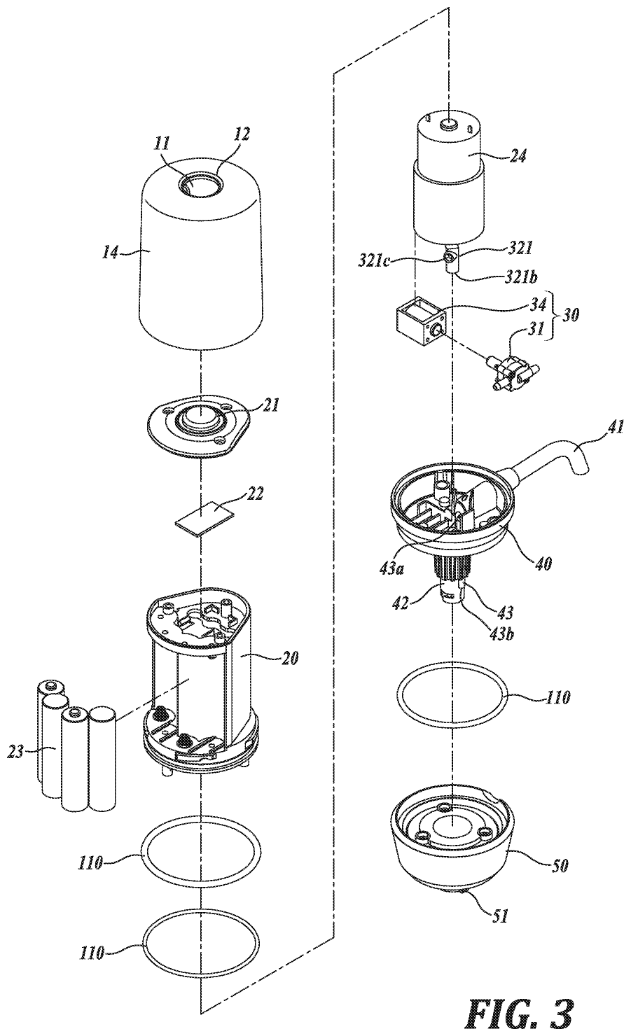

A power pack 20 is disposed within the cavity 11, a top side of the power pack 20 having a button (switch) 21 and a circuit board 22 mounted thereto. A power source 23, such as one or more rechargeable or replaceable batteries, is arranged on peripheral wall of the power pack 20. The power pack 20 is sized and configured to receive a pump 24 into a bottom portion thereof. In the present embodiment, as shown in FIG. 3, the power source 23 set is a battery and the pneumatic element 24 is a waterproof air pump.

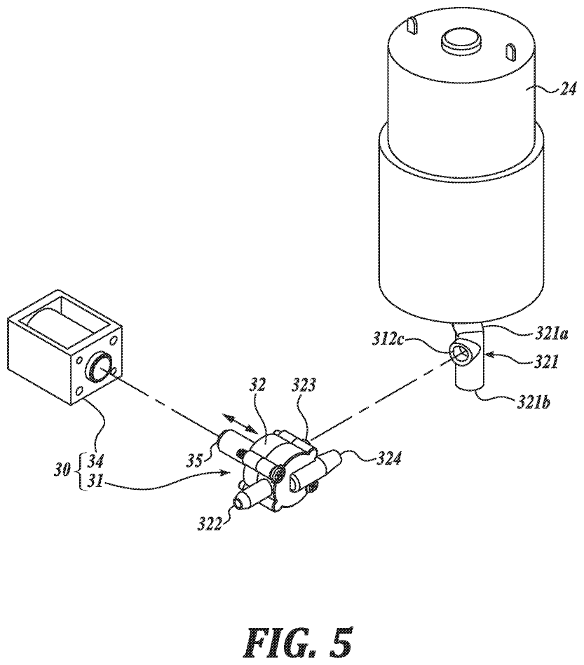

A valve assembly 30 is positioned within the housing 10 on the bottom side of the power pack 20. As best shown in FIGS. 5-7, the valve assembly 30 includes a valve 31 operably coupled to an actuator 34. In the illustrated embodiment, the valve 31 is a 3-way valve 31 having a valve housing 32 with an interior cavity 33. A first port 322, a second port 323, and a third port 324 are formed in the valve housing 32, each port being in fluid communication with the interior cavity 33.

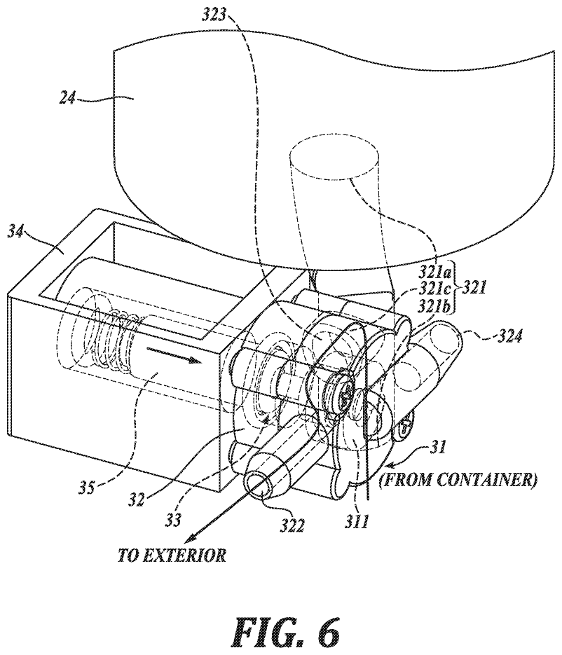

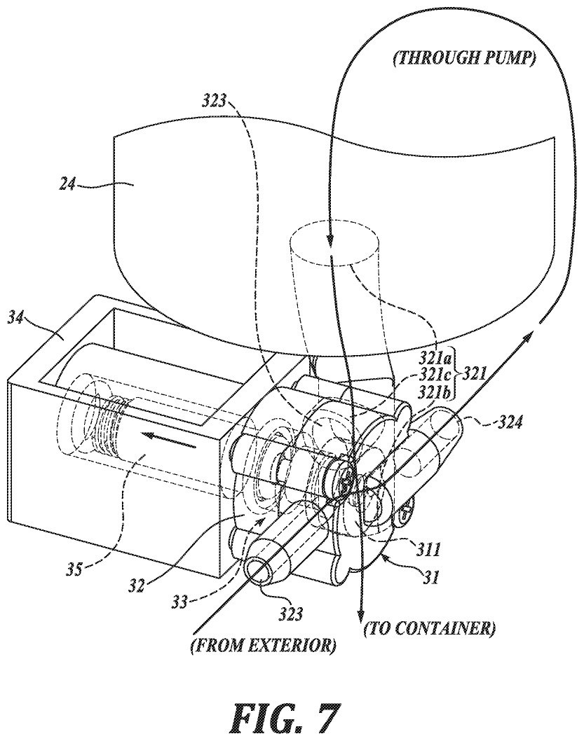

A plug 311 is slidably disposed within the housing 10 and is selectively movable between a first position and a second position. When the plug 311 is in the first position, shown in FIG. 6, the plug blocks the third port 324 so that the first port 322 and the second port 323 are in fluid communication with each other through the valve housing 32, but the third port is blocked from both the first port and the second port. When the plug 311 is in the second position, shown in FIG. 7, the plug blocks the second port 323 so that the first port 322 and the third port 324 are in fluid communication with each other through the valve housing 32, but the second port is blocked from both the first port and the third port.

The plug 311 is coupled to a plunger 35 of the actuator 34. In the illustrated embodiment, the actuator 34 is a solenoid that selectively moves the plunger 35 to reciprocate the plug 311 between the first position (FIG. 6) and the second position (FIG. 7). In the first position, the actuator is in a neutral state, and no current is provided to the solenoid. A spring biases the plunger 35 to maintain the plug 311 in the first position. When an electrical current is provided to the solenoid, the plunger 35 is drawn into the actuator housing against the force of the spring, and the plug 311 is moved to the second position. When the current stops, the spring moves the plunger 35 to return the plug 311 to the neutral first position.

Although the disclosed valve assembly is disclosed with an actuator in the form as a solenoid, it will be appreciated that any suitable actuator may be used to selectively move the valve assembly between (1) a first state, in which first and third ports of a 3-way valve are in fluid connection with each other and are both blocked from a second port, and (2) a second state, in which the first and second ports are in fluid communication from each other and are both blocked from the third port. Further, the valve assembly is not limited to the disclosed valve housing and plug arrangement but may be any suitable valve configuration configured to selectively function in the first and second states described above.

Referring back to FIG. 1-3, the base 40 is coupled to the bottom side of the power pack 20 and covers the valve assembly 30. A connecting element 50 is mounted to the bottom of the base 40 and is sized and configured to receive the neck of a bottle 200. A guide tube 42 extends downward from the base 40 and is sized and configured to be received within the mouth of a bottle 200.

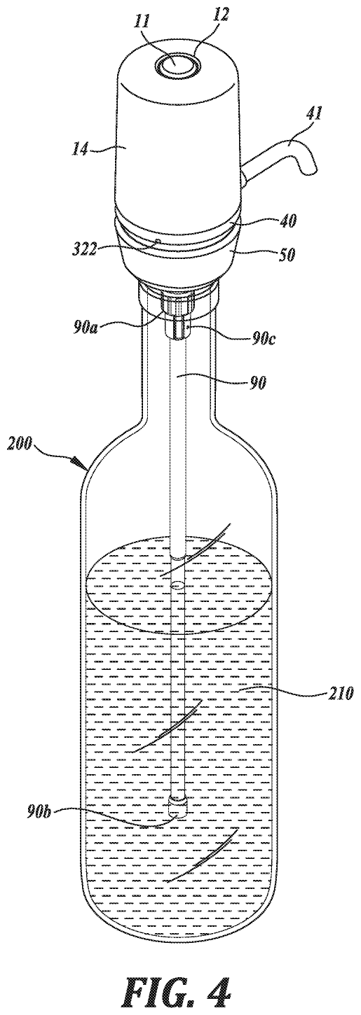

The guide tube 42 includes a conduit in fluid communication with a liquid outlet tube 41 that extends from a peripheral wall of the base 40. As best shown in FIG. 4, a first end 90a of a dip tube 90 is removably connected to the guide tube 42 so that when the liquid dispenser 100 is mounted to a bottle 200, the guide tube 42 extends into the neck of the bottle, and the dip tube 90 extends further into the bottle so that a second end 90b of the dip tube is positioned near the bottom of the interior of the bottle 200. The dip tube 90 also includes one or more aeration holes 90c extending through a wall of the dip tube near the first end 90a. As will be explained further, the aeration hole 90c provides a supply of air to be mixed with the liquid when the liquid is being dispensed.

In the illustrated embodiment, the dip tube 90 is a two-section retractable tube, and the connection of each section of the dip tube 90 is airtight. However, other embodiments of the dip tube are contemplated. In some embodiments, the length of the dip tube 90 is adjustable according to the depth of the bottle 200. In some embodiments, the dip tube 90 includes one or more apertures 90c located extending through a wall of the dip tube near the first end of the dip tube.

The liquid outlet tube 41 cooperates with the guide tube 42 and the dip tube 90 to define a conduit between the bottom of the interior of the bottle 200 and an area outside of the housing 10. That is, during a dispensing activity, liquids in the bottle 200 enter the dip tube 90, flow through the guide tube 42, and are discharged from the liquid outlet tube 41. In the illustrated embodiment, the liquid outlet tube 41 is inclined horizontally with a slight upwards angle between 1-10 degrees to prevent the excess liquid 210 from dripping from the liquid outlet tube 41. That is, when a dispensing activity ends, at least a portion of the liquid 210 remaining in the liquid outlet tube 41 flows back into the bottle 200 under the influence of gravity.

An infusion tube 43 is formed through the base 40 and includes first end 43a and a second end 43b. The first end 43a is positioned within the housing 10 and is in fluid connection with both the pump 24 and the second port 323 of the valve 30 by a pressurization tube 321. As best shown in FIG. 5, the pressurization tube 321 includes a first end 321a in fluid communication with the pump so that the first end of the pressurization tube 321 receives pressurized air from the pump when the pump is activated. A second end 321b of the pressurization tube 321 is in fluid communication with the first end 43a of the infusion tube 43 and, therefore, the interior of the bottle 200. A pressure relief aperture 321c extends through a wall of the pressurization tube 321 and is in fluid communication with the second port 323.

It will be appreciated that the illustrated embodiment of a pressurization tube 321 is exemplary only and should not be considered limiting. In this regard, alternate configurations are contemplated in which various tubes or combinations of tubes are utilized to enable fluid communication between the pump, the second port of the valve, and the infusion tube. As such, the configuration and position of the apertures relative to each other may vary, and such variations should be considered within the scope of the present disclosure.

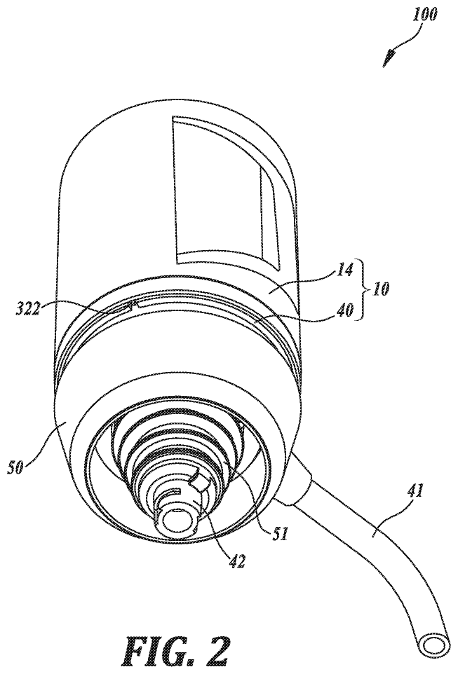

As best shown in FIG. 2, the connecting element 50 includes a flexible cover 51 surrounding the guide tube 42. When the dip tube 90 is not connected to the guide tube 42, the flexible cover 51 blocks the second end 43b of the infusion tube 43 and prevents liquid from being introduced into the pump 24 and the valve assembly 30 through the infusion tube 43 when the liquid dispenser 100 is being cleaned.

When the dip tube 90 is connected to the guide tube 42 during use, i.e., when the liquid dispenser 100 is mounted to the bottle 200 as shown in FIG. 4, the dip tube 90 engages and deflects the flexible cover 51 to unblock the second end 43b of the infusion tube 43. As a result, the interior of the bottle 200 is in fluid connection with the guide tube 43 and the pressurization tube 321.

Mounting the liquid dispenser 100 to the bottle 200 also sealingly engages the flexible cover 51 with the mouth of the bottle 200 to prevent air from overflowing from the junction of the connecting element 50 and the bottle mouth of the bottle 200. This sealed connection allows for pressurization of the interior of the bottle 200 by eliminating or minimizing any pressurized air from escaping through the interface of the bottle and the connecting element 50.

It should be further noted that as shown in FIG. 3, a gasket 110, illustrated as an O-ring, is provided at the each of the joints of the cover body 10, the power pack 20, the base 40 and the connecting element 50, and a waterproof glue or other sealing mechanism provides a seal between the button and the housing 10. As a result, the liquid dispenser 100 is waterproof to prevent liquid penetration into the interior and cause a short circuit when rinsing and soaking in the water.

Referring now to FIGS. 4-7, operation of the liquid dispenser 100 will be described. To begin operation, a user connects the dip tube 90 to the guide tube 42. The dispenser 100 is then mounted to the bottle 200 as shown in FIG. 4 by inserting the guide tube 42 into the neck of the bottle 200 so that the dip tube 90 extends to a bottom portion of the bottle interior. The flexible cover 51 engages with the interior of the neck of the bottle to provide a sealed connection between the liquid dispenser 100 and the interior surface of the bottle neck. The flexible cover 51 also deflects to uncover the outlet 43b of the infusion tube 43. That is, deflection of the flexible cover 51 puts the infusion tube 43 in fluid connection with the interior of the bottle 200.

With the liquid dispenser 100 mounted to the bottle 200, the user presses the button 21 to be begin dispensing liquid. Pressing the button 21 causes the power supply 23 to provide power to the circuit board 22, which energizes the valve assembly 30. Energizing the valve assembly 30, or more specifically, the actuator 34, moves the valve assembly 30 from the first state, shown in FIG. 6, to the second state, shown in FIG. 7. With the valve assembly 30 in the second state, the first port 322 and the third port 324 of the valve assembly are in fluid communication with each other, and the second port 323 is blocked.

Pressing the button 21 also activates the pump 24, which discharges pressurized air into the inlet end 321a of the pressurization tube. Because the second port 323 of the valve assembly 30 is blocked, the pressurized is blocked from being discharged through the pressure release aperture 321c and instead passes through the outlet end 321b of the pressurization tube 321, through the infusion tube 43, and into the bottle 200.

Ambient air is supplied to the pump 24 through the valve assembly 30. In this regard, the first port 322 of the valve assembly 30 is in fluid connection with the ambient air outside of the dispenser 100, and the third port 324 is in fluid connection with both the first port and the interior cavity 11 of the housing 10. As the pump 24 provides pressurized air into the infusion tube 43, the pump draws ambient air through the valve assembly 30 into the interior cavity 11 of the housing 10 to replace the pressurized air discharged into the bottle 200. The path of the airflow from the exterior of the dispenser 100, through the valve assembly 30 and the pump 24, and then into the bottle 200 is indicated by an arrow shown in FIG. 6

The pressurized air supplied to the interior of the bottle 200 applies a force to the surface of the liquid 210 in the bottle 200 that drives the liquid into the second end 90b of the dip tube 90. The liquid 200 passes up through the dip tube 90 into the guide tube 42, and is then discharged from the outlet tube 42 into a glass or other suitable container placed by the outlet tube by the user. As the liquid 210 passes through the dip tube 90, air from inside the container 200 is introduced into the liquid through the one or more aeration holes 90c formed in the dip tube. This air, which enters the dip to due to the pressurization of the air and/or entrainment, mixes with the liquid 210 to aerate the liquid as it is being dispensed.

When the user releases the button 21, the power supply 23 stops providing power to the pump 24 and the valve assembly 30. As a result, the pump 24 stops discharging pressurized air into the container 200, and the valve assembly 30 returns to the first position shown in FIG. 6.

With the valve assembly 30 in the first position, the first port 322 and the second port 323 are in fluid communication with each other, and the third port 324 is blocked. The unblocked first and second ports 322 and 323 provide a pathway to depressurize the bottle. With reference to the arrow shown in FIG. 6, pressurized air within the container 200 vents through the infusion tube 43, into the pressurization tube 321. The pressurized air is then discharged though the pressure release aperture 321c into the second port 323 of the valve assembly 30, after which the pressurized air is discharged from the first port 322 into the ambient air.

The depressurization of the container 200 continues until the pressure inside the container is reaches ambient pressure. As the pressurized air, exits the container, it tends to follow the path so that the air passes through the valve assembly 30 rather than entering the outlet of the pump 24. Pressurized air being vented from the container 200 is also prevented from entering the interior cavity 11 of the housing 10 where the circuit board 22 power supply 23, and actuator 34 are located. By effectively isolating the electronic components and interior pump components from the pressurized air, these components are not exposed to any liquids and/or vapors from inside the container 200 that may be discharged along with the pressurized air. As such, the risk of damage to these components, such as short circuits and/or corrosion, is minimized.

With the interior of the container 200 vented, i.e., depressurized, the liquid remaining in the outlet tube 41 returns to the interior of the container through the dip tube 90 under the force of gravity. The angle of the outlet tube 41 ensures that the liquid will return to the container 200 rather than continue to drip from the outlet tube.

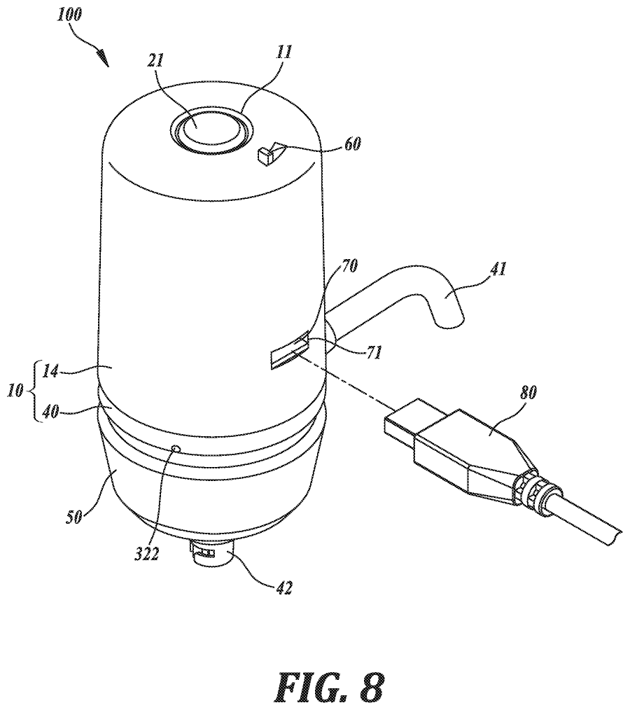

FIG. 8, which is a perspective view of a second embodiment of a liquid dispenser according to aspect of the present disclosure. Compared with the first embodiment, the second embodiment has a main structural difference in that it further comprises a switching element 60 which is disposed on the top side of the power pack 20 and the switching element 60 is protruding from the cover body 10. The switch element 60 is electrically connected to the power supply set 23. In addition, a charging hole 70 is disposed on a recessed area on the peripheral wall of the power pack 20, and a charging perforation 71 is provided at a position of the cover body 10 corresponding to the charging hole 70. The charging hole 70 is matched with a connection port 80 to draw external power to charge the power supply set 23.

In the present embodiment, when the user accidentally touches the button 21 during cleaning, and the pneumatic element 24 starts to operate, the liquid is allowed to pass through the air hole set 32 into the liquid dispenser 100 to cause a short circuit. In the embodiment shown in FIG. 8, the switch element 60 is used to control the opening and closing of the power supply set 23.

However, the present disclosure is not limited to the above embodiments. In another embodiment, a charging element is provided on the peripheral wall of the cover body 10, the charging element is coupled with the connection port, and provides external power to charge the power supply set 23. The charging member is a magnetic charger, or the charging hole 71 is provided with a cover piece to prevent liquid from penetrating from the charging hole 70 into the liquid dispenser 100.

As such, the present embodiment can not only achieve the effect of the first embodiment, but also provide different structures. Through the use of the switch element 60, so that when cleaning the liquid dispenser 100, the accidental touch of the button 21 by the user will not cause the liquid to enter the air hole set 32, which further reduces the potential short circuit of the pneumatic element 24 and the circuit board 22 caused by water. In addition, the installation of the charging hole 70 provides external power to charge the power supply set 23, which further increases the convenience and practicality in use.

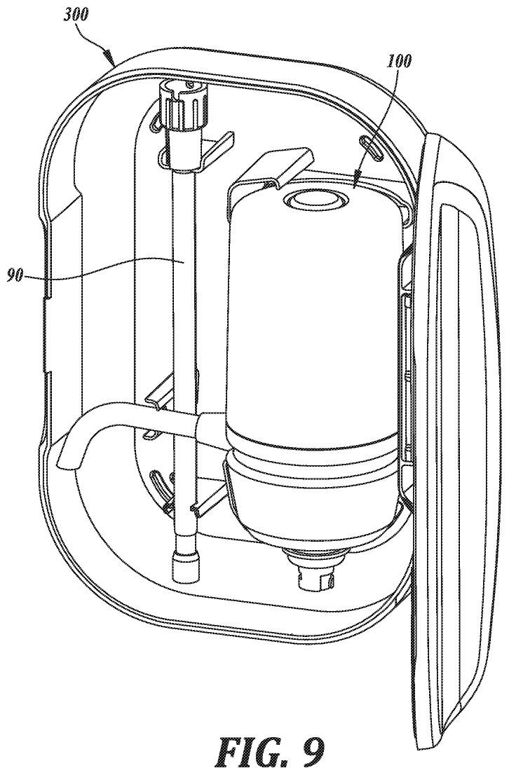

Referring to FIG. 9, a perspective view of the liquid dispenser kit is shown. The kit includes a storage box 300, which is used to accommodate the liquid dispenser 100 and the dip tube 90. Thereby, the third embodiment can not only achieve the effects of the first and second embodiments, but also provide a container for the user to conveniently receive the liquid dispenser 100 and the dip tube 90.

Although the disclosed subject matter has been described with reference to the preferred embodiments thereof, it is apparent to those skilled in the art that a variety of modifications and changes may be made without departing from the scope of the present disclosure.

Certain embodiments disclosed herein utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used.

In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes one or more processors or portions thereof and accompanying software, firmware, hardware, and the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Moreover, some of the method steps can be carried serially or in parallel, or in any order unless specifically expressed or understood in the context of other method steps.

In the foregoing description, specific details are set forth to provide a thorough understanding of exemplary embodiments of the present disclosure. It will be apparent to one skilled in the art, however, that the embodiments disclosed herein may be practiced without embodying all of the specific details. In some instances, well-known method/process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

1. A liquid dispenser mountable to a container having an interior portion, the liquid dispenser comprising:
a housing defining an interior cavity;
a pump;
a pressurization tube having a first end configured to receive pressurized air from the pump, a second end in fluid communication with the interior portion of the container, and a pressure relief aperture extending through a wall of the pressurization tube between the first end and the second end; and
a valve disposed within the interior cavity of the housing, the valve comprising a first port in fluid communication with an area exterior the housing, a second port in fluid communication with the pressure relief aperture, a third port in fluid communication with the interior cavity of the housing; and a plug selectively movable between a first position, in which the plug blocks the third port, and a second position, in which the plug blocks the second port, wherein the first port is in fluid communication with the second port when the plug is in the first position, and the first port is in fluid communication with the third port when the plug is in the second position.

2. The liquid dispenser of claim 1, further comprising an outlet tube extending laterally from the housing and having a first end in fluid communication with the interior of the container when the liquid dispenser is mounted to the container.

3. The liquid dispenser of claim 2, further comprising a dip tube having a first end in fluid connection with the first end of the outlet tube, the dip tube having a second end positioned near a bottom of the interior of the container when the liquid dispenser is mounted to the container.

4. The liquid dispenser of claim 3, wherein the dip tube has an adjustable length.

5. The liquid dispenser of claim 1, further comprising a switch selectively movable between a first switch position and a second switch position, wherein movement of the switch from the first switch position to the second switch position moves the valve from the first position to the second position.

6. The liquid dispenser of claim 5, wherein movement of the switch from the first switch position to the second switch position activates the pump.

7. The liquid dispenser of claim 5, wherein the movement of the switch from the second switch position to the first switch position moves the valve from the second position to the first position.

8. The liquid dispenser of claim 7, wherein movement of the switch from the second switch position to the first switch position deactivates the pump.

9. The liquid dispenser of claim 5, further comprising an actuator operably coupled to the valve, the actuator selectively positioning the plug to reciprocate the valve between the first position and the second position.

10. The liquid dispenser of claim 9, wherein the actuator is a linear actuator.

11. The liquid dispenser of claim 9, the actuator being a solenoid comprising a selectively retractable plunger, wherein the plug is mounted to the plunger.

12. The liquid dispenser of claim 1, further comprising a connecting element positioned on a bottom portion of the housing, the connecting element being sized and configured to engage an aperture formed in the container.

13. The liquid dispenser of claim 12, wherein the connecting element comprises an infusion tube having a first end in fluid connection with the outlet end of the pressurization tube, a second end of the infusion tube being in fluid connection with the interior portion of the container.

14. The liquid dispenser of claim 13, further comprising:
a dip tube selectively attachable to the connecting element; and
a flexible cover engaging the connecting element to block the second end of the infusion tube when the dip tube is not attached to the connecting element, the dip tube deflecting the flexible cover to uncover the second end of the infusion tube when the dip tube is attached to the connecting element.

15. A liquid dispenser mountable to a neck of a bottle to sealingly engage a mouth of the bottle, the liquid dispenser comprising:
a housing;
a pump disposed within the housing and having an outlet;
a pressurization tube having a first aperture in fluid communication with the pump outlet, a second aperture in fluid communication with an interior of the bottle, and a third aperture; and
a valve disposed within the housing, the valve comprising a first port in fluid communication with an area outside of the housing, a second port in fluid communication with the third aperture of the pressurization tube, a third port in fluid communication with an interior cavity formed in the housing; and a plug selectively movable between a first position, in which the plug blocks the third port, and a second position, in which the plug blocks the second port, wherein the first port is in fluid communication with the second port when the plug is in the first position, and the first port is in fluid communication with the third port when the plug is in the second position.

16. The liquid dispenser of claim 15, wherein the third aperture of the pressurization tube is positioned between the first and second apertures of the pressurization tube.

17. The liquid dispenser of claim 15, further comprising a connecting element extending from the housing, the connecting element being sized and configured to be at least partially received within the mouth of the bottle.

18. The liquid dispenser of claim 17, wherein the connecting element includes an infusion tube extending therethrough, a first end of the infusion tube being in fluid communication with the second aperture of the pressurization tube, a second end of the infusion tube being in fluid communication with the interior of the bottle.

19. The liquid dispenser of claim 18, further comprising:
a dip tube selectively attachable to the connecting element; and
a flexible cover engaging the connecting element to block the second end of the infusion tube when the dip tube is not attached to the connecting element, the dip tube deflecting the flexible cover to uncover the second end of the infusion tube when the dip tube is attached to the connecting element.

20. The liquid dispenser of claim 19, further comprising an outlet tube extending laterally from the housing and having a first end in fluid communication with the dip tube.
